(19) United States
(12) Patent Application Publication
(10) Pub. No.: US 2005/0272490 A1
(43) Pub. Date: Dec. 8, 2005

(54) Wireless network device with rotary antenna

(75) Inventor: Hui-Tsang Chang, Hsinchu (TW)

Correspondence Address: BRUCE H. TROXELL;SUITE 1404, 5205 LEESBURG PIKE, FALLS CHURCH, VA, 22041, US

(73) Assignee: Acradyan Technology Corporation

(21) Appl. No.: 10/950,516

(22) Filed: Sep. 28, 2004

(30) Foreign Application Priority Data
Jun. 8, 2004 (TW) 93208985

(51) Int. Cl. H04M 1/00

(52) U.S. Cl. 455/575.7; 455/575.1

(57) ABSTRACT

The wireless network device with rotary antenna of the present invention comprises: a main body, having a housing for receiving a circuit of wireless networking capability; a connection port, coupled to an end of the housing of the main body, for connecting to a connecting interface of a computer; an antenna part, pivotally connected to a coupling point arranged at another end of the housing of the main body, capable of rotating about the coupling point. The present invention provides a rotary antenna that can be rotated to adjust the reception angle at will for ensuring the stability of wireless signal while using the same for wireless accessing.

### 1. FIELD OF THE INVENTION

The present invention relates to a wireless network device with rotary antenna, and more particularly, to an external network interface card having an external antenna connected thereto and being used for connecting to a connection interface of a desktop PC or notebook PC for ensuring the stability of wireless signal while using the same for wireless accessing.

### 2. BACKGROUND OF THE INVENTION

Ubiquitous access to information, anywhere, anyplace, and anytime, will characterize whole new kinds of information systems in the 21st Century. These are being enabled by rapidly emerging wireless communications systems, based on radio and infrared transmission mechanisms, and utilizing such technologies as cellular telephony, personal communications systems, wireless PBXs, and wireless local area networks. Currently, a notebook PC with Intel Centrino inside using IEEE 802.11g specification is the most popular wireless communication device capable of communicating with any available access points for wireless communication. However, for other non-Intel/Centrino notebook PCs to be able to perform wireless accessing, it is required to connect the same with an external network interface card through a connection interface thereof, which can be PCMIA, USB, IEEE 1394, etc, or it is required to use a or built-in network interface card.

Both the external and built-in network interface cards of prior art employ fixed antenna for receiving/transmitting RF signal. For an external network interface card which is the smaller the better, its antenna is also the smaller the better, that it is preferred to be able to adjust the reception angle of the antenna so as to avoid the network interrupt caused by bad reception. To solve the problem as mention above, the present invention provides a wireless network device with rotary antenna.

### SUMMARY OF THE INVENTION

In view of the shortcomings as disclosed above, it is the primary object of the invention to provide a wireless network device with rotary antenna, capable of adjusting the reception angle of the antenna so as to avoid the network interrupt caused by bad reception by using a rotary antenna instead of a stationary antenna of a conventional wireless network interface card, such that the present invention can ensure the stability of wireless signal while using the same for wireless accessing.

To achieve the above object, the wireless network device with rotary antenna of the present invention comprises:
a main body, having a housing for receiving a circuit of wireless networking capability;
a connection port, coupled to an end of the housing of the main body, for connecting to a connecting interface of a computer;
an antenna part, pivotally connected to a coupling point arranged at another end of the housing of the main body, capable of rotating about the coupling point.

With the following drawings and detailed descriptions, the objects, features, and advantages of the present invention are described in detail.

### BRIEF DESCRIPTION OF THE DRAWINGS

FIG. 1 is an exploded view of a wireless network device with rotary antenna according to the present invention.

FIG. 2 is diagram showing a wireless network device with rotary antenna of the present invention.

FIG. 3 is schematic diagram showing a first state of a wireless network device with rotary antenna according to the present invention.

FIG. 4 is schematic diagram showing a second state of a wireless network device with rotary antenna according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

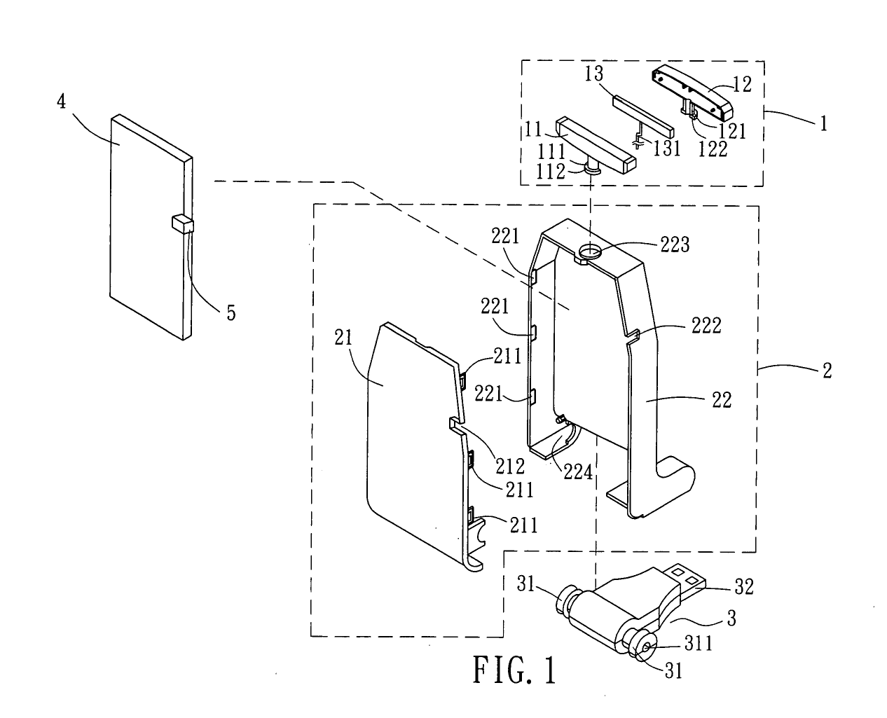

Please refer to FIG. 1, which is an exploded view of a wireless network device with rotary antenna according to the present invention. The wireless network device of FIG. 1 comprises: an antenna 1, a main body 2 and a connection port 3.

The antenna part 1 is consisted of a front 11, a rear 12 and a metal plate-like antenna 13. Both the front 11 and the rear 12 are concave lids, and together can form a housing with a chamber therein by attaching the two face to face, such that the chamber is used for receiving the metal plate-like antenna 13. In addition, a semicircular column is protruding from the front 11, which the portion of the column connected to the front 11 has a reduced diameter so as to form a front axle 111 and the portion away from the front 11 forms a front flange 112. Corresponding the front 11, similarly a semicircular column is protruding from the rear 12, which the portion of the column connected to the rear 12 has a reduced diameter so as to form a rear axle 121 and the portion away from the rear 12 forms a rear flange 122. Together, a pivotal axle is formed by attaching the front axle 111 to the rear axle 121 and the front flange 112 to the rear flange 122 correspondingly. Moreover, a wire 131 connected to the antenna 13 is extending inside the hollow axle formed by attaching the front flange 112 to the rear flange 122.

The main body 2 is consisted of a cover 21 and a base. 22. The cover 21 and the base 22 can be joint as a whole structure by buckling the plural tenon 211 disposed on the cover 21 to the corresponding buckling holes 221 of the base 22. An opening 212 is arranged on the cover 21 corresponding to an opening 222 arranged on the base 22, and together the two openings 212, 222 form a L-shape opening on the whole structure of the cover 21 and the base 22. Moreover, the base 22 has a first axle hole 223 arranged at the top side of the same for accepting the pivotal axle of the antenna part 1, where the flange is abutted against the inner side of the first axle hole 223 for enabling the antenna part 1 to rotate 360 degree at the top of the main body 2 without falling. The lower side of the base 22 is bended and two second axle holes 224 are respectively arranged at the left and the right side of the bended portion of the base 22.

Moreover, a circuit 4 of wireless networking capability is placed in the chamber formed between the cover 21 and the base 22. The circuit 4 further has a luminant 5 arranged with respect to the L-shape opening such that the state of the luminant 5 can be used for representing the status of the wireless accessing. The wire 131 of the antenna 13 is connected to the circuit 4 for communicating signals between the antenna 13 and the circuit 4.

The connection port 3 has two pivotal axles 31 symmetrically and respectively arranged at the left and the right side of the connection port 3, which can be buckled with the corresponding second axle hole 224 of the main body 2 for enabling the connection port 3 to rotate about the main body 2. In addition, the circuit 4 has at least a cable electrically connected to a connecting interface 32 through a penetrating hole 311 disposed at the axial center of the two pivotal axles 31. The connection port 3 can connect with a designated computer interface using the connecting interface 32. In a preferred embodiment of the invention, the connecting interface 32 is an USB interface. It is obvious to those skilled in the art that the connecting interface 32 is not limited to be an USB interface, it also can be a IEEE 1394 interface, a PCMCIA, etc.

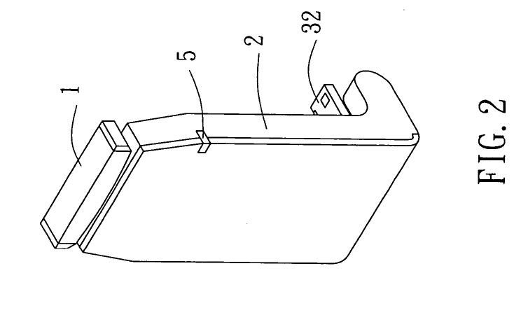

The assembly of the components as disclosed above can be seen in FIG. 2.

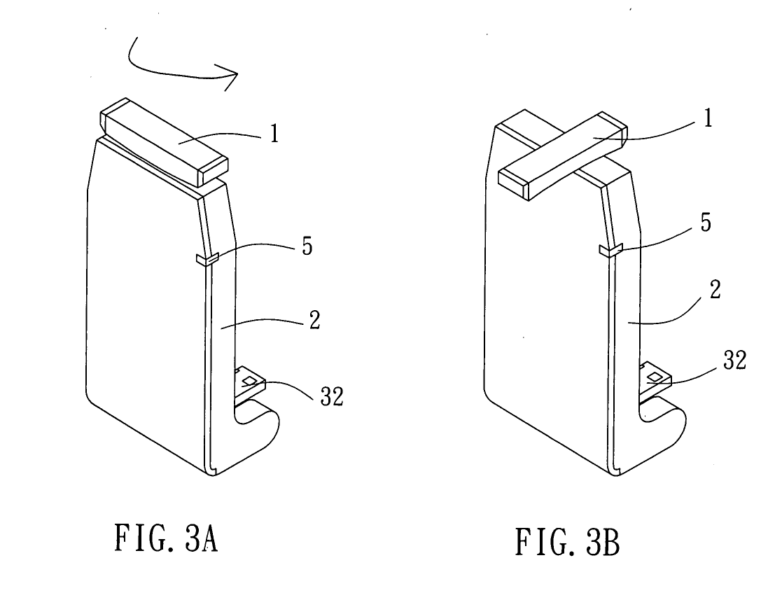

Please refer to FIG. 3A and FIG. 3B, which are respectively a first state and second state of a wireless network device with rotary antenna according to the present invention. The antenna part 1 can be rotated by 360 degree with respect to the main body 2, that is, the bar-shaped antenna part can be placed in parallel to the top side of the main body as seen in FIG. 3A, and the bar-shaped antenna can also be placed perpendicular to the top side of the main body 2 as seen in FIG. 3B. In this regard, for an external network interface card which is the smaller the better, its antenna is also the smaller the better, that is able to adjust the reception angle of the antenna so as to avoid the network interrupt caused by bad reception. The present invention provides a rotary antenna that can be rotated to adjust the reception angle at will for ensuring the stability of wireless signal while using the same for wireless accessing.

To sum up, the objects and features of the present invention are shown to have great improvement and industrial merits that have not yet disclosed. According to the spirit of the patent law, the present invention undoubtedly meets the requirements.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A wireless network device with rotary antenna, comprising:
a main body, having a housing for receiving a circuit of wireless networking capability;
a connection port, coupled to an end of the housing of the main body, for connecting to a connecting interface of a computer;
an antenna part, pivotally connected to a coupling point arranged at another end of the housing of the main body, capable of rotating about the coupling point.

2. The wireless network device with rotary antenna of claim 1, wherein the housing and the antenna part is connected through a pivotal axle for enabling the antenna part to rotate about the housing.

3. The wireless network device with rotary antenna of claim 1, wherein the connecting interface is an IEEE 1394 interface.

4. The wireless network device with rotary antenna of claim 1, wherein the connecting interface is a USB interface.

5. The wireless network device with rotary antenna of claim 1, wherein the connecting interface is a PCMCIA interface.

6. The wireless network device with rotary antenna of claim 1, wherein a metal plate-like antenna is arranged inside the antenna part.

7. The wireless network device with rotary antenna of claim 1, wherein the connection port is coupled to the main body by pivotally connecting a pivotal axle to the corresponding axle holes of the main body for enabling the connection port to rotate about the main body.
